(19) United States
(12) Patent Application Publication
(10) Pub. No.: US 2024/0053059 A1
(43) Pub. Date: Feb. 15, 2024

(54) HEATING DEVICE FOR HEATING WATER, AND WATER-CONDUCTING APPLIANCE COMPRISING A HEATING DEVICE

(71) Applicant: Miele & Cie. KG, Guetersloh (DE)

(72) Inventors: Daniel EBKE, Bielefeld (DE); Werner STROTHOFF, Sassenberg (DE); Rainer BICKER, Verl (DE); Volker ENNEN, Buende (DE)

(21) Appl. No.: 18/267,262

(22) PCT Filed: Nov. 30, 2021
(86) PCT No.: PCT/EP2021/083563

§ 371 Date: Jun. 14, 2023

(30) Foreign Application Priority Data
Dec. 14, 2020 (BE) 2020/5918

(51) Int. Cl. F24H 9/20; F24H 1/10; F24H 15/128; F24H 15/31

(52) U.S. Cl. CPC F24H 9/2028; F24H 1/106; F24H 15/128; F24H 15/31

(57) ABSTRACT

A heating device for heating water having a container having an inlet and an outlet, two spaced-apart plates which act as electrodes and are each connected to an electrical voltage source for generating a current flow through the water located between the plates, and a control device for activating and deactivating a valve at the inlet and for activating and deactivating the voltage source. A water-conducting device, such as a washing machine, dishwasher or hot beverage maker, includes a flow line system and a heating device arranged therein, as described above.

### RELATED APPLICATIONS

The present disclosure claims priority to and the benefit of PCT Application PCT/EP2021/083563, filed on Nov. 30, 2021, which claims priority to and the benefit of Belgium Application 2020/5918, filed on Dec. 14, 2020, the entire contents of both of which are incorporated herein by reference.

### TECHNICAL FIELD

The disclosure relates to a heating device for heating water, comprising a container having an inlet means and an outlet means.

### BACKGROUND

In water-conducting devices, such as a washing machine, dishwasher or beverage maker, heated water is required during operation and is provided by means of a heating body or a continuous heater installed within the treatment container. In this case, electrical resistance heating elements are used which heat up when the electrical current flow is connected and, by contact with the water, transfer the heat into the water. This means that a heat transfer from the heating body to the water always takes place which is subject to losses or delays the heating of the water.

DE 10 2014 217 842 A1 discloses a heating device for a beverage maker as a continuous flow heater.

### SUMMARY

The object of the disclosure is to provide an improved heating device for an effective and versatile operation for heating water.

According to the disclosure, this object is achieved, inter alia, by a heating device having the features of independent claim 1 and by a water-conducting device according to claim 13. Advantageous features and further embodiments of the disclosure can be found in the respective dependent claims.

An advantage achieved with the disclosure is that the heating takes place very precisely and the temperature specified by the user or the process control is maintained very precisely with extremely small fluctuations. Furthermore, the heating of the water is accomplished more quickly than with conventional continuous-flow heaters, heating plates or hoses.

For this purpose, the heating device comprises two spaced apart plates within the container which function as electrodes and each comprise an electrical connection for connection to an electrical voltage source in order to generate a current flow through the water located between the plates. The electrodes direct the voltage applied to the plates directly into the liquid, so that an electrical current flows through the water which is located in the space between the two plates. Due to the electrical conductance or resistance of the water, it is heated without a heat transfer from a heated body to the water taking place. This means that the water is heated directly. The preferred method is to use an AC voltage in the frequency range of the common mains frequency at the electrodes in order to prevent electrolysis, i.e. to reduce it or prevent it from occurring. The plates are preferably spaced apart parallel to one another. As the plates act as electrodes, they only have to have a low transitional resistance to the water, so that they preferably consist of graphite or have a graphite surface. The heating device further comprises a control device for activating and deactivating the inlet means and for activating and deactivating the voltage source in order to perform the desired heating task depending on the overall process in the device being used.

Overall, the heating device is designed for use in a water-conducting device, preferably for use in a washing machine, a dishwasher or a hot beverage maker.

In a preferred embodiment, the heating device comprises a detection means for detecting the conductance of the water located between the plates. The control device is preferably configured to adjust the inlet means and/or the voltage source as a function of the detected conductance. The conductance is furthermore strongly dependent on the properties or composition of the water, in particular of mineral additives and the temperature, so that the water supply and/or the voltage applied to the plates and thus the current flowing through the water can be adjusted automatically depending on the properties and the process requirements.

In an advantageous embodiment, the inlet means comprises a controllable valve, wherein the control device is configured to open and close the controllable valve. A simply constructed and precisely controllable heating device is thus provided. The water is thus supplied with a delivery pressure or a higher supply reservoir from which the water presses on the inlet valve due to gravity.

In an expedient embodiment, the outlet means further comprises a valve, wherein the valve is preferably designed to be controllable and the control device is configured to open and close the controllable outlet valve.

In an overall advantageous embodiment, the control device is configured to control the inlet means and the voltage source and preferably the outlet means for different operating modes. The operating modes can depend on the overall process when used with equipment that includes water heating as a sub-process.

For this purpose, the heating device, in particular the control device, is configured to select as operating mode and carry out one or more of the operating modes
Pumping;
Mixing and
Steam generation.

In the pumping operating mode, the control device is configured to control the inlet valve in such a way that a pulsating delivery of the water is set. Alternatively, a predetermined inflow of fresh water can also be set which is low enough that, due to the heat-induced expansion of the water in the container, continuous conveyance to the outlet is set.

In the steam generation operating mode, the control device is configured to control the inlet valve in such a way that a level with a free volume above the plates is set in the container. This results in evaporation above the plates, wherein the steam is conveyed out of the outlet due to the vapor pressure. Overheating of the exposed panels cannot occur because the conductance in the air or in the steam is significantly less than in the water. The plates subjected to electrical voltage do not heat up.

In the mixing operating mode, the control device is configured to control the inlet valve in such a way that a level in the container is established at which the plates are completely flooded and a convection flow of the water within the container can be set. The convection flow causes an ascending flow between the two plates and a descending flow at the intermediate spaces of the plates to the respectively adjacent container wall. As a result, the water circulates within the container, so that added substances, such as detergents, are mixed in and/or dissolved in the water.

In an overall expedient embodiment, the heating device comprises a detection means for detecting the level of the water located in the container or between the plates. As a result, the amount of water in the container which is necessary for the desired operating mode can be introduced very precisely.

In an overall expedient embodiment, the container volume is at a value in the range from 50 ml to 2000 ml. This is sufficient for a heating device of the aforementioned type for most applications in water-conducting household appliances and can be accommodated in the corresponding devices without significant design effort.

In a further advantageous embodiment, the plate size has a value in the range of 10 cm2 (square centimeters) to 500 cm2 (square centimeters).

The disclosure further relates to a water-conducting device, such as a washing machine, dishwasher or hot beverage maker, comprising a flow line system and a heating device arranged therein according to one of the aforementioned embodiments.

### BRIEF DESCRIPTION OF THE DRAWINGS

An embodiment of the disclosure is shown purely schematically in the drawings and is described in more detail below. In the drawings:

FIG. 1, 2, 3: are diagrammatic views of a heating device in a preferred embodiment and in different operating modes;

FIG. 4: is a diagrammatic view of the heating device in the embodiment as a pump;

FIG. 5: is a diagrammatic perspective open view of a hot beverage maker, and

FIG. 6: is a diagrammatic view of a washing machine.

### DETAILED DESCRIPTION OF THE DRAWINGS

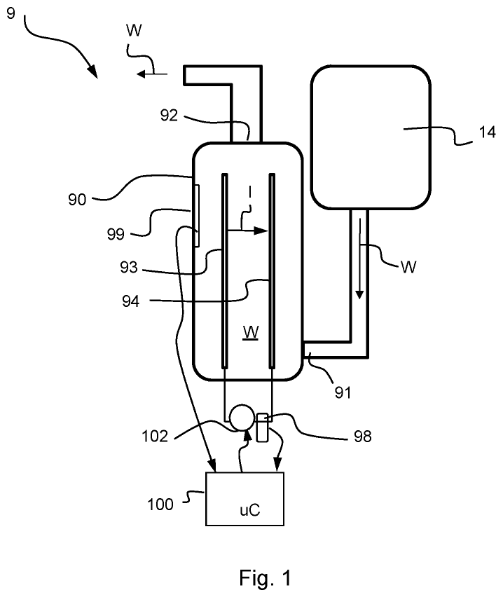

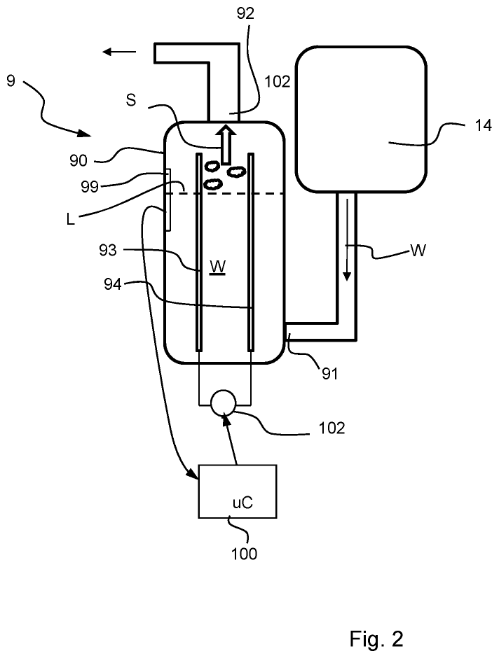

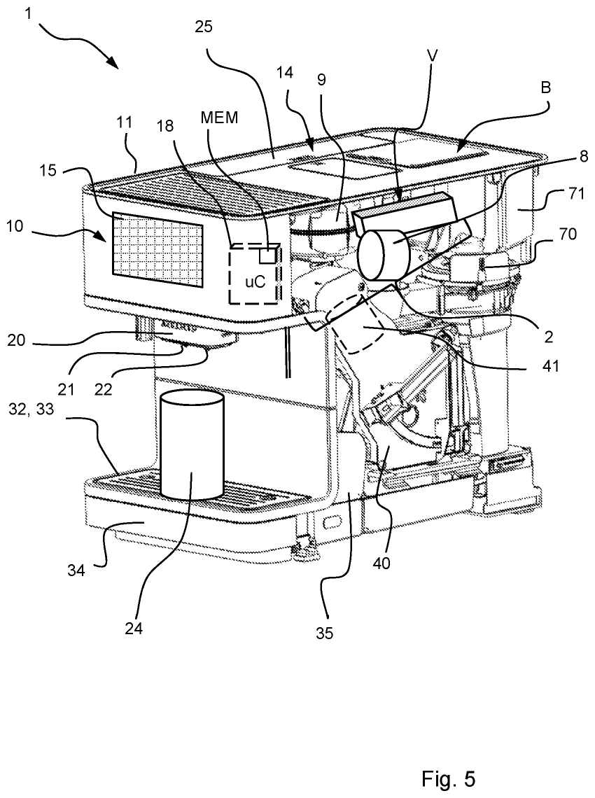

FIG. 1 schematically shows the heating device 9 in a preferred embodiment in the situation of a water heater. This device 9 comprises a container 90 having an inlet channel 91 and an outlet channel 92 and, within the container 90, two spaced plates 93, 94 which act as electrodes and each comprise an electrical terminal for connection to an electrical voltage source 102 for generating a current flow I through the water W located between the plates. The control device 100 is designed to control the voltage source 102 and thereby switch a corresponding AC voltage to the plates 93, 94. With the detector 98, such a conductivity detector, sensor, probe or equivalent detection means, the conductance of the liquid W located in the container can be detected and fed to the control device 100. Based on the detected conductance and the predetermined requirements for water heating, the control device 100 can activate the voltage source 102 in order to bring about the desired heating of the water W. In this case, the heating device 9 is designed as a continuous heater; it can also be designed as a boiler. Furthermore, the heating device 9 comprises a sensor 99 for detecting the water level within the container 90. This may be a conductive or capacitive sensor attached to the wall of the container 90 and in contact with the water W. The water source 14 is designed as a container; it can also be provided by means of a supply line from a water supply network and an inlet valve. The water W is thereby conveyed from the source 14 at the inlet 91, through the container 90 and out of the outlet 92. This can be provided by means of a pump 8, 87 (FIG. 5, 6) from the device application.

FIG. 2 shows the heating device 9 in the application as a steam generator. In this case, the container 90 is not completely filled with water W, which means that there is a space above the level L. The water W is heated here in the manner described above. When the water W is heated, steam S is produced, which initially collects in the space above the water level L and is discharged through the outlet 92. The control device 100 controls the voltage source 102 in such a way that the water W is heated enough that steam S is produced. In this case, the inlet means 91 can be designed as a controllable valve which is likewise controlled by the control device 100 in order to introduce a predetermined level of water W into the container 90. The level L can be detected by the level sensor 99, and, on the basis of the detected level value, the control device 100 can admit the required quantity of water for steam generation from the water source 14 into the container 90.

FIG. 3 shows the heating device 9 in the application as a mixer. In this case, the container 90 is not completely filled with water W, which means that there is a space above the level L. However, the level L is dimensioned such that the two plates 93, 94 are completely flooded. In this case, the water W is heated in the manner described above. When the water W is heated, the water W is heated only to the extent that no steam or only a little steam is produced. No water W is discharged through the outlet 92 during the circulation. The control device 100 controls the voltage source 102 in such a way that the water W is heated only to such an extent that a circulation within the container 90 is produced. The water W heated between the plates 93, 94 rises due to convection. The water flows past the upper edge of the plates 93, 94 and downward again at the edge of the container 90. As a result of the circulation, a mixture of substances admitted together with the water can take place. After mixing, the liquid can be drained or pumped out of the outlet means 92.

In this case, the inlet means 91 can be designed as a controllable valve which is likewise controlled by the control device 100 in order to admit the predetermined level of water W into the container 90 for the application desired in each case. The level L can be detected with the level sensor 99 and, on the basis of the detected level value, the control device 100 can admit the required quantity of water for circulation from the water source 14 into the container 90.

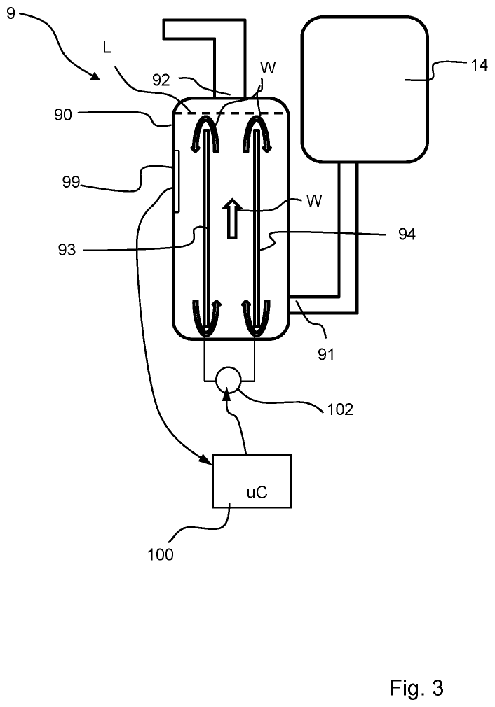

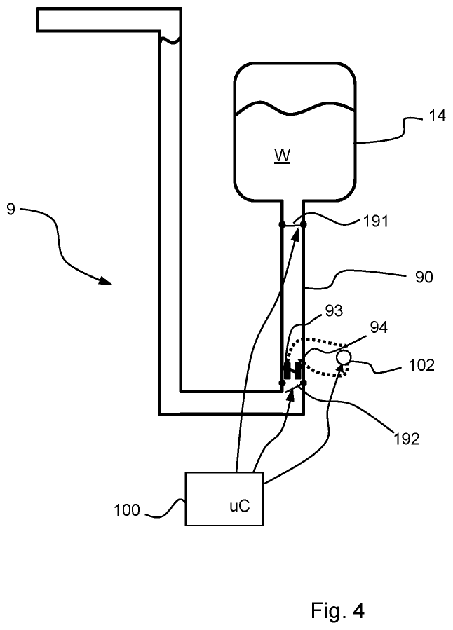

FIG. 4 shows the heating device 9 as a schematic view in the application as a pump with a heater. The container 90 is filled completely with water W, wherein the inlet means 191 is closed after the filling is completed. In this case, the inlet means 191 is designed as a controllable valve 191. However, the level is dimensioned such that the space between the inlet valve 191 and the outlet means 192 is completely flooded the two plates 93, 94. In this case, the water W is heated in the manner described above. When the water W is heated, it is intended to expand within the container 90. Due to the resulting fluid pressure, the water W is discharged from the container 90 out of the outlet 192. The control device 100 controls the voltage source 102 and the inlet valve 191 in such a way that the water W from the source 14 is introduced into the container 90 in a metered manner, heated and, due to the expansion resulting therefrom, is discharged from the container 90 independently and in liquid form.

For all operating modes and functions, the voltage source 102 provides an AC voltage, preferably with a frequency in the range of the mains frequency, i.e., in the range from 16.7 to 60 Hz.

The function of the pump is explained as follows by way of example

Start:
System is filled, the heating element consisting of the two plates 93, 94 is deactivated.
The inlet valve 191 is opened; water flows into pump chamber 90
Outlet valve 192 is opened as appropriate, so that water W flows into the further tube (optional/makes sense if no higher pressure is to be expected in the system)

Expansion Phase
Inlet valve 191 closed (activation by means of motor, solenoid or self-closing via float or spring, and only based on the pressure conditions in the fluid system);
Outlet valve 192 opened (electrically controlled or as a self-closing check valve, for example via spring or float, which is pressed open by the overpressure in pump chamber 90);
Heating element activated, electrical voltage applied to plates 93, 94=>steam rises and cannot escape through inlet valve 191. As a result, water W is displaced downward into the pump chamber 90;
Expansion phase ends when heating element 93, 94 is not covered/only partially covered.
Repetition of the aforementioned steps from “Start.”

This provides a pulsating pump.

FIG. 5 shows the example of a hot beverage maker 1 designed as a stand-alone device with all relevant components for the preparation of a hot beverage. The beverage maker 1 comprises, among other things, a housing 11 in which the storage container 71 for coffee beans B with grinder 70 mounted thereunder with motor, the water tank 14 and the possibility of accommodating the flow line system 2. The housing 11 also serves as a support frame for the brewing unit 40, wherein, in the inserted position, an oblique position of the brewing chamber 41 results. In the front region of the hot beverage maker 1, the latter has a height-movable outlet 20 in which a plurality of removal devices, in this case outlet nozzles 21, 22, are accommodated. In the present case, the removal device 22 is a steam nozzle for dispensing hot steam or hot water, for example for diluting a finished coffee or for preparing a tea beverage. The removal device 21 represents a dispensing line or dispensing nozzle 21 for dispensing coffee beverages. A brewing unit 40 with a brewing chamber 41 in the interior of the device 1 serves for preparation of the beverage, wherein the coffee powder is introduced into the brewing chamber 41 and is subsequently flooded with hot water so that the finished coffee beverage is dispensed to the discharge line and through the dispensing nozzle 21. The upper end of the storage surface 33 forms a drip plate 32, which is provided with openings and slits, in order to remove liquid residues in a collecting tray 34 that is present below the drip plate 32. Furthermore, the hot beverage maker 1 comprises a test container 35, into which the used substance, for example coffee cake, is cast after completion of the beverage preparation. The device 1 further comprises a control device 18, which is configured to control the individual functional assemblies, such as pumps 8, valve arrangement V and heating device 9 (in the form of a continuous water heater) and grinder 70, if present, as is necessary for the preparation of the respectively selected beverage. In this embodiment, the control device 18, which is designed as a microcontroller uC with an associated memory MEM, is also configured to control the valves V of the flow-line system 2 such that the hot water is pumped through the brewing chamber 41. An operating and display device 15 arranged on the front panel 10 provides the operational means for user inputs and a display for state indications or input options for preparing beverages. The operating and display device 15 is preferably designed as a touch screen. The control tasks for the heating device 8 can be implemented or integrated in the control device 18 of beverage maker 1.

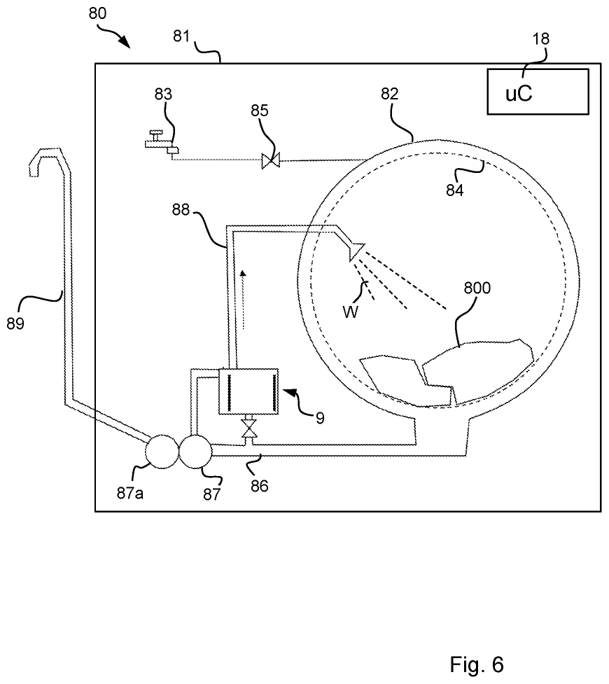

FIG. 6 schematically illustrates a washing machine 80 as an example of a water-conducting device. The washing machine 80 contains a housing 81 in which all essential components for carrying out an automated washing process are necessary. These include the washing solution container 82, the drum 84 rotatably driven therein, and the control device 18. Furthermore, a water connection 83 for connection to the supply network and a controllable inlet valve 85 are present in order to introduce water W into the washing solution container 82 and the drum 84. The drainage device 86 below the washing solution container 82 serves to connect a recirculation pump 87 to convey the water W or the washing liquor admixed with washing agent out of the washing solution container 82 via the recirculation line 88 into the upper region of the drum 84 and inject it there. Arranged on the pressure side of the pump 87 is the heating device 9, which is designed as a continuous-flow heater, wherein the recirculation line 88 is connected at the outlet 92 (FIGS. 1 to 4) of the heating device 9. Furthermore, the drainage hose 89 is closed off at the drainage device 86 in order to convey the applied washing liquor or water W out of the washing solution container 82 by means of the drainage pump 87a.

The control device 18 serves to activate and deactivate the pump 87, drive for the drum 94, the heating device 9 and the valves 85 in order to carry out the desired washing process for the laundry 800. The control tasks for the heating device 9 can be implemented or integrated in the control device 18 of the washing machine 80.

1. A heating device for heating water, comprising:
a container having an inlet and an outlet;
two spaced-apart plates which act as electrodes and are each connected to an electrical voltage source for generating a current flow through the water located between the plates;
a control device for activating and deactivating the inlet moans and for activating and deactivating the voltage source.

2. The heating device according to claim 1, comprising a detector for detecting the conductance of the water ON) located between the plates, wherein the control device is configured to adjust a controllable valve at the inlet and/or the voltage source as a function of the detected conductance.

3. The heating device according to claim 1, wherein the inlet comprises a controllable valve and the controller is configured to open and close the controllable inlet valve.

4. The heating device according to claim 1, wherein the outlet comprises a valve, wherein the valve is designed to be controllable and the control device is configured to open and close the controllable outlet valve.

5. The heating device according to claim 3, wherein the controller is configured to control the controllable inlet valve and the voltage source for different operating modes.

6. The heating device according to claim 5, wherein one or more of the operating modes
Pumping,
Mixing, and
Steam generation
can be selected as the operating mode and carried out.

7. The heating device according to claim 6, wherein, in the pumping operating mode, the control device is configured to control the controllable inlet valve in such a way that a pulsating delivery of the water is established.

8. The heating device according to claim 6, wherein, in the steam generation operating mode, the control device is configured to control the controllable inlet valve such that a level with a free volume above the plates is set in the container.

9. The heating device according to claim 6, wherein, in the mixing operating mode, the controller is configured to control the controllable inlet valve such that a level in the container is set at which the plates are fully flooded and a convection flow of the water within the container can be set.

10. The heating device according to claim 1, further comprising a sensor for detecting the level of water located in the container or between the plates.

11. The heating device according to claim 1, wherein the container volume comprises a value in the range 200 ml to 2000 ml.

12. The heating device according to claim 1, wherein the plate size has a value in the range from 10 cm² to 500 cm², and the distance of the plates has a value in the range from 5 cm to 0.5 cm.

13. A water-conducting device comprising a flow line system and a heating device arranged therein according to claim 1.

14. The water-conducting device of claim 13, wherein the device is a washing machine, dishwasher or hot beverage maker.

15. The heating device according to claim 5, wherein the controller is further configured to control the controllable outlet valve for different operating modes.
